(19) United States
(12) Patent Application Publication
(10) Pub. No.: US 2010/0246367 A1
(43) Pub. Date: Sep. 30, 2010

(54) OPTICAL INFORMATION RECORDING METHOD AND APPARATUS USING THE SAME

(75) Inventors: Hideaki OKANO, Kanagawa-ken (JP); Takashi Usui, Saitama-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/720,151

(22) Filed: Mar. 9, 2010

(30) Foreign Application Priority Data
Mar. 24, 2009 (JP) 2009-072778

(51) Int. Cl. G11B 7/00

(52) U.S. Cl. 369/103; G9B/7.113

(57) ABSTRACT

An optical information recording method includes the following steps. A converting step is converting a light beam into an information beam carrying information by using a spatial beam modulator. A focusing step is focusing the information beam on an optical information recording medium including an information recording layer. An irradiating step is irradiating the optical information recording medium with a reference beam and the information beam so that the reference beam and the information beam intersect with each other on the information recording layer by using an optical component. A rotating step is rotating the optical information recording medium or the optical component by using a drive unit for performing angle-multiplex recording. A management information recording step is recording management information at two or more relative angles having an angle interval smaller than twice at least a first null angle.

### CROSS REFERENCE TO RELATED APPLICATION

This application is based upon and claims the benefit of priority from the prior Japanese Patent Application No. 2009-072778, filed on Mar. 24, 2009, the entire contents of which are incorporated herein by reference.

### FIELD OF THE INVENTION

The present invention relates to an optical information recording method and an optical information recording apparatus to record information as a hologram.

### DESCRIPTION OF THE BACKGROUND

An optical information recording medium typified by CD (Compact Disk), DVD (Digital Versatile Disk), Blue-ray Disc, HD DVD (Hi-Definition Digital Versatile Disk), etc. has contributed to an increase in a recording density. For example, the recipes for the increase include shortening the wavelength of laser light and increasing a numerical aperture (NA) of an object lens. However, both the recipes are considered to approach the technical limit thereof. A novel method or principle is required to increase the recording density.

Recently, a high-density recording method of volumetrically recording type (referred to as a “holographic memory” hereinafter) and a holographic recording/reproducing apparatus have been developed for practical use. In the holographic memory, a spatial beam modulator (or a spatial light modulator) modulates laser light spatially to generate an information beam carrying information. Furthermore, a reference beam is generated from the light source of the information beam. The reference beam has the same wavelength as the information beam. The information beam and the reference beam are directed to the same spot inside an optical information recording medium to record interference fringes in the spot of the optical information recording medium. The interference fringes are generated by the interference between the information beam and the reference beam.

When reproducing in the holographic memory, only the reference beam is directed to the spot to reproduce the information beam at the time of recording, thereby allowing it to obtain the information modulated at the time of recording. DVD, etc. employs a surface recording mode where recording marks are recorded on the surface of DVD, whereas a holographic optical disk employs volumetric recording which allows it to record in a thickness direction of an information recording layer. Thereby, the holographic optical disk acquires a higher recording density than DVD.

DVD records marks as bit data of ON/OFF, while the information beam is recorded as interference fringes to which relatively many pieces of information are modulated collectively in the holographic memory. A set of pieces of information is a modulated pattern of the information beam stored in the optical information recording medium, i.e., a two-dimensional bar-code unit for recording/reproducing which includes black-and-white dots and is called “page data”.

One of the methods to increase the recording density of the holographic memory is multiplex recording. This multiplex recording is a mode which records two or more page data on the same spot of the holographic recording medium. Examples of the multiplex recording proposed include angle-multiplex recording with shifting the incident angle of a laser beam, shift multiplex recording with shifting a beam position slightly, and wavelength multiplex recording with shifting the wavelength of a laser beam.

In the angle-multiplex recording or the shift multiplex recording, changing a relative position or angle of the laser beam to the optical information recording medium enables multiplex recording. The angle-multiplex recording system is a novel mode which has been never employed in conventional CD and DVD recorders, and is essential to so-called a dual beam interference mode which records interference fringes generated between an information beam and a reference beam onto a recording layer.

The angle-multiplex recording modes include two technologies. One rotates the recording medium without changing the position of a laser beam to perform multiplex recording. The other rotates the position of the laser beam around the recording medium to perform multiplex recording. The rotation axis thereof is generally set to pass through an axis (y-axis) perpendicular to an incident plane (x-z plane) of the information beam and the reference beam. The rotations of the recording medium and the position of the laser beam are called a θ_{y} rotation. The multiplicity due to the rotation is called a θ_{y} multiplicity.

Moreover, materials of the recording medium for the holographic memory have been recently developed using a photopolymer, and some are close to practical use. The photopolymer is an organic material which induces a change in the refractive index thereof in response to light irradiation, thereby showing various reaction mechanisms depending on organic material employed. The photopolymer is cured to become soft and gumlike, and it is, therefore, difficult to hold the simple body thereof. The photopolymer is poured into a space formed between a pair of glass substrates sandwiching a properly thick spacer, thereby forming a recording layer held by the pair of glass substrates.

The recording medium using a photopolymer is easy to manufacture, while the recording medium is vulnerable to a temperature change. The vulnerability arises from two points. One is that the thermal expansion coefficient of the photopolymer differs from that of the glass substrate by two orders of magnitude. The other is that the refractive index of the photopolymer changes greatly with temperature. When the recording temperature to record information on the recording medium differs from the reproducing temperature to read out the information, a diffracting grating recorded deforms. The deformation of the diffracting grating arises from the fact that the deformation thereof parallel to the glass substrate depends dominantly on the thermal expansion of the glass substrate, and the deformation thereof vertical to the glass substrate depends dominantly on the thermal expansion of the photopolymer. This also causes a problem that only a fraction of the recorded information is reproduced as a result of the different reproducing conditions in the same page data.

When recording page data at an angle θ_{y} is followed by recording different page data, the angle θ_{y} is changed so that a crosstalk does not arise from adjacent pages when reproducing. When reproducing page data, a clear reproduction image is obtained all over as shown in FIG. 11-1, if there is no difference between the temperatures for reproducing and recording the page data. If there is a difference between the temperatures for reproducing and recording the page data, the diffraction grating in the recording medium deforms to shift the reproducing condition. Accordingly, only a fraction of the reproduction image is obtained as shown in FIG. 11-2. The larger the temperature difference is, the narrower the fraction is. When the angle θ_{y} is multiplexed, the deformed diffraction grating causes partial overlapping of reproducing conditions on adjacent pages. In such a case, fractions of page data on several adjacent pages are reproduced alongside of a fraction of page data on a desired page as shown in FIG. 11-3. As mentioned above, the temperature difference makes it difficult to reproduce when the angle θ_{y} is multiplexed.

In order to solve the problem due to the temperature difference, a method is proposed. In the method, the temperature of a recording medium is recorded when recording and the wavelength of light is tuned with reference to the data of the recorded temperature when reproducing (JP-A 2006-267554 (KOKAI)).

In the above-mentioned method, it is necessary to firstly read the temperature data recorded. However, a wavelength or angle most suitable for reproducing is unknown in an initial condition. Therefore, it takes time to reproduce in the initial condition. When the temperature difference is larger, it is impossible to determine the most suitable wavelength or angle, thereby making it impossible to reproduce.

### SUMMARY OF THE INVENTION

According to a first aspect of the invention, an optical information recording method includes a converting step, a focusing step, an irradiating step, a driving step, and a management information recording step. The converting step is converting a light beam emitted from a light source into an information beam carrying information by using a spatial beam modulator. The focusing step is focusing the information beam on an optical information recording medium including an information recording layer. The irradiating step is irradiating the optical information recording medium with a reference beam and the information beam so that the reference beam and the information beam intersect with each other on the information recording layer by using an optical component. The information recording layer is capable of recording information as a hologram due to interference fringes generated by interference between the information beam and the reference beam. The rotating step is rotating the optical information recording medium or the optical component by using a drive unit to change relative angles among the information beam, the reference beam and the optical information recording medium for performing angle-multiplex recording of the information onto the information recording layer. The management information recording step is recording management information at two or more relative angles having an angle interval smaller than twice at least a first null angle, the management information being used for reading out user information recorded on the optical information recording medium.

According to a second aspect of the invention, an optical information recording apparatus includes a spatial beam modulator, an optical component, a drive unit, and a control unit. The spatial beam modulator modulates laser light spatially to generate an information beam carrying information. The laser light is emitted from a light source. The optical component focuses the information beam on an optical information recording medium including an information recording layer in order to irradiate the optical information recording medium with a reference beam and the information beam so that the reference beam and the information beam intersect with each other on the information recording layer. The information recording layer is capable of recording information as a hologram due to interference fringes generated by interference between the information beam and the reference beam. The drive unit rotates the optical information recording medium or the optical component. The control unit performs angle-multiplex recording of the information on the optical information recording medium by controlling the light source to emit the beam while rotating the optical information recording medium or the optical component so that relative angles among the information beam, the reference beam and the optical information recording medium are changed. In addition, the control unit records the same pieces of management information at two or more relative angles having an angle interval smaller than twice at least a first null angle. The management information is used when reading out user information.

### BRIEF DESCRIPTION OF DRAWINGS

The accompanying drawings, which are incorporated in and constitute a part of this specification, illustrate embodiments of the invention and together with the description, serve to explain the principles of the invention.

FIG. 1 is a view showing a composition of a holographic memory recording/reproducing apparatus.

FIG. 2 is a flow chart showing the procedure of management information recording process.

FIG. 3 is a view showing a crosstalk between adjacent pages.

FIG. 4 is a view showing a relationship between an angle interval of adjacent pages and diffraction efficiency.

FIG. 5 is a view schematically showing management information recorded by management information recording processing.

FIG. 6 is a flow chart showing steps of the management information reproduction processing.

FIG. 7 is a view to explain a θ_{y} angle when reproducing the management information.

FIG. 8 is a view schematically showing page data of the management information read by the management information reproduction processing.

FIG. 9 is a view to explain a bit display of a spatial beam modulator.

FIG. 10 is a view to explain another bit display of the spatial beam modulator.

FIG. 11-1 is a view showing a reproduction image of information recorded by a conventional recording mode.

FIG. 11-2 is a view showing another reproduction image of information recorded by a conventional recording mode.

FIG. 11-3 is a view showing another reproduction image of information recorded by a conventional recording mode.

### DETAILED DESCRIPTION OF THE EMBODIMENTS

Embodiments of the invention are explained with reference to the accompanying drawings below.

### First Embodiment

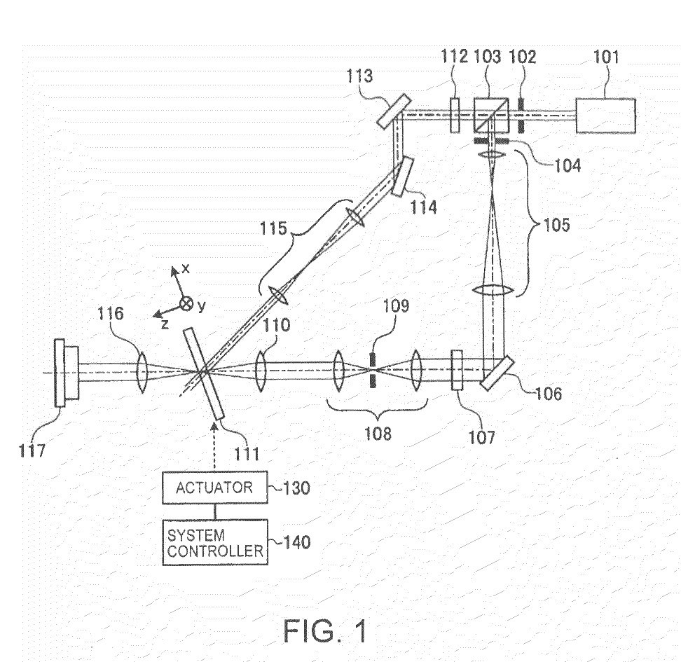

FIG. 1 is a view showing a holographic memory recording/reproducing apparatus 100 which is provided with main optical components. The holographic memory recording/reproducing apparatus 100 records information on an information recording layer of an optical information recording medium 111, and reads out the information recorded on the information recording layer. The information recording layer is referred to simply as the “recording layer” hereinafter. In the optical information recording medium 111, two glass substrates sandwich a photopolymer with a thickness of 0.2 mm to 2.0 mm therebetween, for example, thereby forming the recording layer in the optical information recording medium 111. When the recording layer is exposed to a light beam, the refractive index of an area exposed to the light beam changes. Thereby, when the intensity distribution of light is resulted from a two-beam interference, the diffraction grating due to the interference fringes will be written in. Information is recorded on the optical information recording medium 111 as the diffraction grating.

The operation for recording information in the holographic memory recording/reproducing apparatus 100 is explained with reference to FIG. 1. A parallel pencil emitted from a laser light source 101 passes through a shutter 102 to be incident on PBS (polarized beam splitter) 103. An s-polarized beam is reflected by PBS 103 to be employed as an information beam. A p-polarized beam passes through PBS 103 to be employed as a reference beam. The s-polarized beam reflected passes through the shutter 104 to be incident on a relay lens 105. The beam diameter of the s-polarized beam is expanded by the relay lens 105 to make the s-polarized beam a parallel pencil so that the s-polarized beam is incident on a spatial beam modulator 107 with making the beam-intensity thereof uniform to some extent. Then, the parallel pencil is reflected by a reflection mirror 106 to be amplitude-modulated into page data of two-dimensional bar-codes by the spatial beam modulator 107. As the spatial beam modulator 107, a transmissive LCD (LCD: Liquid Crystal Display), a reflective FLCOS (FLCOS: Ferroelectric Liquid Crystal On Silicon), DMD (Digital Micromirror Device), etc. can be employed.

The beam diameter of the information beam which was amplitude-modulated is changed into a size fit to the incidence diameter of an object lens 110 by the relay lens 108. A Nyquist aperture 109 is disposed at the position of a beam waist to be formed by the relay lens 108. The position of the beam waist has a plane for Fourier transform of the intensity distribution of the information beam which is amplitude-modulated by the spatial beam modulator 107. A Fourier-transform image of the information beam is conjugate to the information beam near the optical information recording-medium 111. The size of the Nyquist aperture 109 defines a beam diameter of the information beam near the optical information recording-medium 111. When recording information, the optical information recording-medium 111 is scanned parallel to the surface thereof, thereby allowing it to record with a small step as the size of the information beam is small near the optical information recording-medium 111. That is, the recording density increases as the size of information beam is small. Therefore, it is desirable to minimize the Nyquist aperture 109 as much as possible.

The information beam having been incident on the object lens 110 is given a lens power to be focused near the optical information recording-medium 111. A focusing position may be not only inside the optical information recording-medium 111, but outside the optical information recording medium 111.

On the other hand, a reference beam which passes through PBS 103 is converted into the s-polarized beam by a λ/2 plate 112. The reflection mirrors 113 and 114 reflect the reference beam which is changed by the relay lens 115 into a beam with the diameter mostly same as that of the information beam on the optical information recording medium 111. Then, the reference beam is allowed to be incident on the optical information recording medium 111 as a parallel pencil. More minutely, the reference beam is incident on the same position of the optical information recording medium 111 as the information beam. Then, the information beam and the reference beam interfere with each other, and interference fringes generated are recorded onto the recording layer of the optical information recording medium 111 as a change in the refractive index of the recording layer.

In angle-multiplex recording, the optical information recording medium 111 is irradiated simultaneously with the information beam and the reference beam as mentioned above while rotating the optical information recording medium 111 around a rotation axis lying in the recording layer thereof and passing through the irradiated position thereof.

Here, a xyz orthogonal coordinate system is introduced to be fixed to the recording layer of the optical information recording medium 111. A recording spot irradiated with the information and reference beams is chosen as an origin. A z-axis is taken in a thickness direction, i.e., perpendicularly to the surface of the optical information recording medium 111. Then, an x-axis and a y-axis are taken in directions perpendicular to the z-axis, i.e., in in-plane directions of the recording layer of the optical information recording medium 111 to be normal to each other.

The holographic memory recording/reproducing apparatus 100 performs θ_{y} angle-multiplex recording around the y-axis (the in-plane axis). Specifically, a system controller 140 controls an actuator to record two or more pieces of information with rotating the optical information recording medium 111 around the y-axis by each θ_{y}-angle step (Δθ_{y}) and irradiating the medium 111 with both the information beam and the reference beam at each θ_{y} angle. The θ_{y} rotation changes a relative angle among the information beam, the reference beam and the optical information recording medium 111, thereby allowing it to record different page data. Here, the θ_{y}-angle step is a unit angle to perform the θ_{y} rotation of the optical information recording medium 111 for the θ_{y} multiplex recording.

In this embodiment, the optical information recording medium 111 is rotated to change the relative angle among the information beam, the reference beam and the optical information recording medium 111. Alternatively, the relative angle can be changed by controlling optical components such as mirrors in order to control the emission direction of the reference beam. In this case, the reflection mirror 114 is replaced with a galvanometer mirror, and the relay lens 115 is arranged so that the reflection plane of the galvanometer mirror is conjugate to the recording spot of the optical information recording medium 111. The reflection mirror 114 is rotated to change the relative angle.

Moreover, although the θ_{y} multiplex recording is performed in this embodiment, embodiments of the invention are not limited to this. For example, 0, multiplex recording may be performed so that information is recorded with rotating the optical information recording medium 111 around the z-axis by each θ_{z}-angle step (Åθ_{z}). Moreover, a recording principle using the θ_{y} multiplex recording in combination with the θ_{z} multiplex recording may be employed.

There are user information and management information as information to be recorded on the optical information recording medium 111. Here, the user information (referred to as the “user data” hereinafter) is information recorded by instructions from a user. Management information is used by the holographic memory recording/reproducing apparatus 100 when reading out the user data recorded on the optical information recording medium 111.

The management information includes followings:
a temperature when recording user data;
an angle interval to change the relative angle among the information beam, the reference beam and the optical information recording medium 111 when recording the user data; and
a wavelength of the laser light source 101 when recording user data, etc.

For example, when reproducing the user data, reading out the temperature for recording the user data allows it to identify reproducing conditions such as an optimal angle pitch for reproducing, a wavelength of the laser light source 101 based on the temperature. Recording the angle pitch or the wavelength of the laser light source 101 preliminarily at the time of recording allows it to identify optimal reproducing conditions.

Moreover, when user data has been already recorded, address information may be recorded as management information. The address information specifies a physical position where user data is recorded in the optical information recording medium 111. Reading out the address information for reproducing allows it to identify the recorded position where the user data was recorded.

Moreover, a standard image may be recorded as management information. The standard image is recorded in order to maintain the compatibility of a recording drive. For example, when adjusting according to the characteristic of the recording drive, the standard image to display a certain regular pattern is preliminarily recorded, thereby allowing it to adjust image quality, etc. Moreover, when synthesizing two or more reproduction images for reproducing, a needed read-out angle interval may be recorded as a piece of management information.

As mentioned above, management information is to be used when reading user data. For this reason, the management information is desirably read out as rapidly as possible, and as certainly as possible.

A performance for reproducing information in the holographic memory recording/reproducing apparatus 100 is explained with reference to FIG. 1. A beam emitted from the laser light source 101 passes the shutter 102, and PBS 103 makes a p-wave and an s-wave serve as the information beam and the reference beam, respectively, as well as in recording. However, the shutter 104 is shut in reproducing. Thereby, the information beam is shut off here. The reference beam serves as a parallel pencil, and is directed to the optical information recording medium 111, as well as in recording. The system controller 140 controls an actuator 130 so as to set the θ_{y} angle of the optical information recording medium 111 to a suitable angle. Thereby, a reproduction beam which fulfills reproduction conditions comes out of the optical information recording medium 111. This reproduction light beam passes through the lens 116 to be allowed to enter into a two-dimensional array sensor 117. The two-dimensional array sensor 117 acquires image data to be amplitude-modulated by the spatial beam modulator 107. The image data are processed by the signal-processing circuit (not shown), and read out as data. As the two-dimensional array sensor 117, CCD and CMOS can be employed, for example.

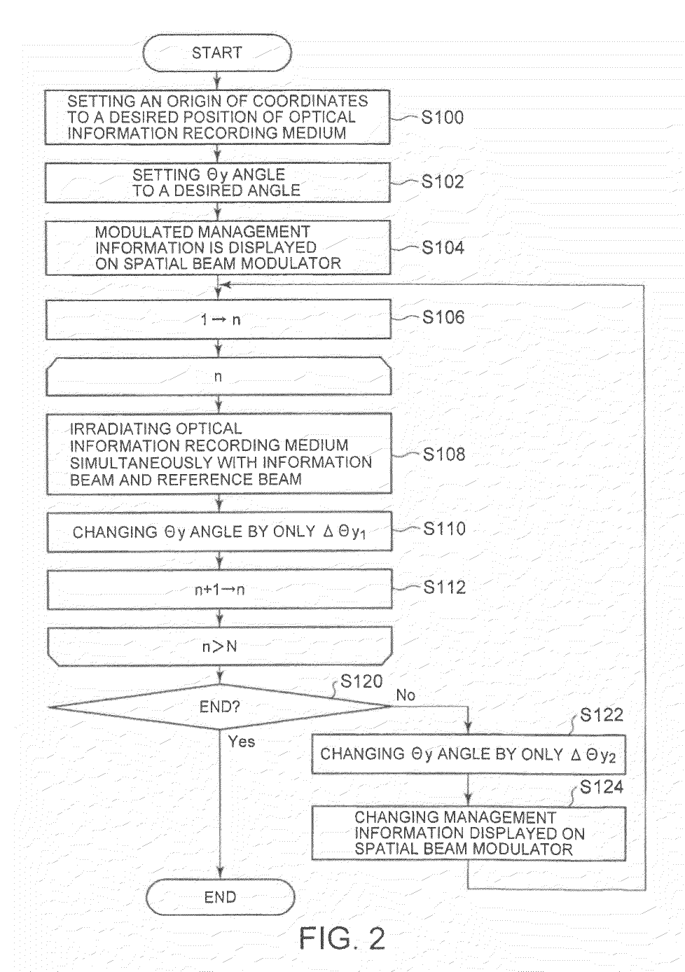

Next, management information record processing is explained. In the processing, the holographic memory recording/reproducing apparatus 100 constituted as mentioned above records management information. In the management information record processing, as shown in FIG. 2, the system controller 140 sets an origin of coordinates to a desired position of the optical information recording medium 111 firstly (Step S100). Furthermore, the θ_{y} angle is set to a desired angle (Step S102). The spatial beam modulator 107 displays the modulated management information (Step S104). Here, the system controller 140 sets “1” to the variable n (Step S106). The system controller 140 controls to irradiate the optical information recording medium 111 simultaneously with the information beam and the reference beam for a constant time (Step S108), thereby writing management information on a predetermined page of the optical information recording medium Hi.

The system controller 140 controls the actuator 130 to rotate the optical information recording medium 111, thereby changing the θ_{y} angle by only Δθ_{y1} (Step S110), without changing the management information displayed on the spatial beam modulator 107 in order to continuously record the same pieces of the management information. The system controller 140 adds 1 to the variable n (Step S112). Processing from Step S108 to Step S112 is repeated until the variable n reaches N. The same pieces of the management information are recorded over the recording angle range of Δθ_{y1}×N through the above processing.

Optimal reproducing conditions cannot be acquired as a result of a temperature change, etc. in some cases. Even so, the same pieces of the management information are recorded as two or more continuous page data to allow it to read out a piece of the management information in case that the piece of the management information coincides with any one of reproducing conditions for page data within the recording angle range.

It is desirable that continuous page data of the management information fully generates a crosstalk. That is, Δθ_{y1} is set as a value within an angle range where the crosstalk takes place as a result of a difference between temperatures for the recording and reproducing of the optical information recording medium 111. The same pieces of the management information are recorded in the angle range where the crosstalk takes place, thereby allowing it to acquire the management information from reproduction images even when fractions of two or more adjacent page data are reproduced simultaneously.

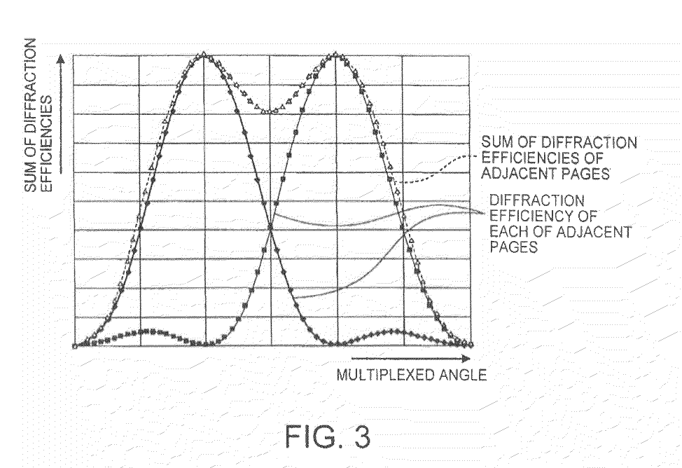

FIG. 3 is a view showing a crosstalk of adjacent pages. The horizontal axis of the graph in FIG. 3 shows a multiplexed angle. The vertical axis thereof shows diffraction efficiencies. When generally making θ_{y} serve as a variable, the brightness of a reproduction beam from a recorded page is proportional to the square of a sine function. When two page data are recorded at intervals of an angle (first null angle) at which the diffraction efficiency firstly becomes 0, the sum of the diffraction efficiencies in the middle of the two adjacent peaks is 80% of the diffraction efficiency at each peak, as shown in FIG. 3, thereby showing that a sufficient crosstalk takes place.

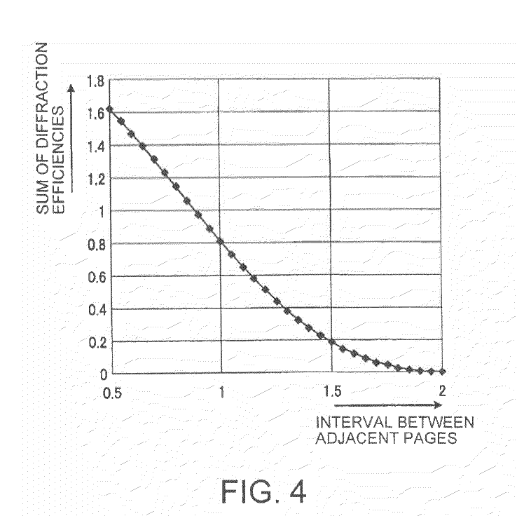

Furthermore, when changing the angle interval of the adjacent page data, i.e., the adjacent page interval, the diffraction efficiency just in the middle changes as shown in FIG. 4. The horizontal axis of the graph in FIG. 4 represents an angle interval of the adjacent page data. In addition, the first null angle is normalized to 1. The vertical axis represents the sum of the diffraction efficiencies of the page data in the middle angle of each angle interval. In addition, the value at the peak of the diffraction efficiency corresponding to 1-page data is normalized to 1. As shown in FIG. 4, at the angle twice the angle of the first null, the diffraction efficiency is mostly zero. That is, the crosstalk does not take place. Therefore, Δθ_{y1} is desirably smaller than an angle twice the first null angle.

As mentioned above, in order to surely reproduce in spite of the crosstalk, it is desirable to record the same pieces of management information over the recording angle range where the sufficient crosstalk takes place. Therefore, N is desirably a value at which the value of the recording angle range (Δθ_{y1}×N) becomes larger than the first null angle, for example.

After repeating the processing from Step S108 to Step S112 to record predetermined management information, the system controller 140 instructs the actuator 130 to rotate the θ_{y} angle by only Δθ_{y2} (Step S122) in order to further record other management information (“No” at Step S120). Here, Δθ_{y2} is desirably an angle which does not generate a crosstalk with the adjacent page data. That is, it is desirable that Δθ_{y2} is larger than the first null angle at a minimum.

The system controller 140 changes the management information displayed on the spatial beam modulator 107 (Step S124). And, “1” is again set to the variable n (Step S106), and the processing from Step S108 to the step S112 is repeated until the variable n reaches N. Thereby, the changed management information is recorded over a recording angle range of Aθ_{y1}×N. Through the above-mentioned process, all the management information is recorded to end management information recording process (“Yes” at Step S120).

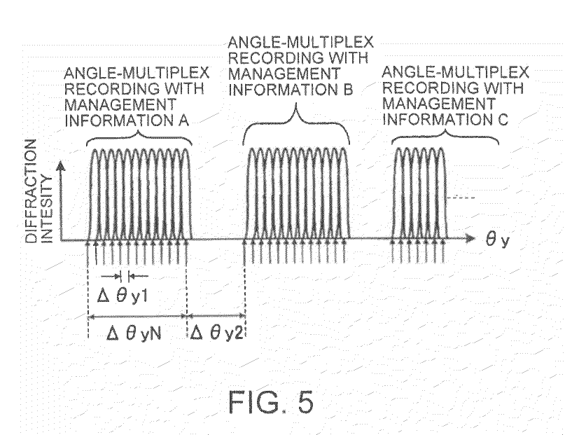

FIG. 5 is a view showing a relationship of θ_{y} angles among the management information A, the management information B, and the management information C each recorded via the above processing. The horizontal axis of the graph in FIG. 5 represents the θ_{y} angle, and the vertical axis represents diffraction intensity. As shown in FIG. 5, two or more data of the management information A are recorded as page data which are continuous over the recording angle range (Δθ_{y1}×N). The management information A and the management information B are separated by only the angle Δθ_{y2} at which no crosstalk takes place. That is, the angle Δθ_{y2} is a difference between the initial angle of the management information B and the terminal angle of the management information A.

The same pieces of management information are continuously recorded over the recording angle range, thereby allowing it to read out desired management information in case that a reproducing angle coincides with any angle within the recording angle range even if the most suitable condition is not acquired when reproducing. The respective page data are recorded every angle interval generating a crosstalk. Therefore, even simultaneously reproducing fractions of two or more adjacent page data allows it to exactly acquire management information from this image simultaneously reproduced, as the adjacent page data are the same as the management information. Furthermore, the angle intervals to record different management information are separated by the angle which generates no crosstalk, thereby allowing it to exactly read out the different management information when reproducing. Therefore, the different management information can be read out rapidly and certainly.

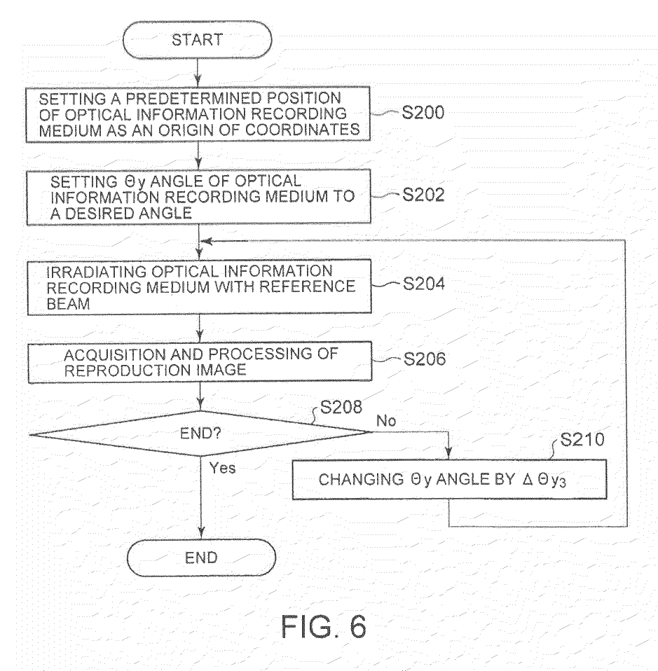

Reproduction processing for the holographic memory recording/reproducing apparatus 100 to reproduce management information is explained with reference to FIG. 6. In the reproduction processing of management information, as shown in FIG. 6, the system controller 140 first sets a predetermined position of the optical information recording medium 111 as an origin of coordinates (Step S200). The system controller 140 instructs the actuator 130 to set the θ_{y} angle of the optical information recording medium 111 to a desired angle (Step S202). Here, the θ_{y} angle is desirably an angle which lies in the middle of the recording angle range within which management information is recorded.

The optical information recording medium 111 is irradiated with a reference beam (Step S204). A reproduction image is acquired by the two-dimensional array sensor 117 and processed by the signal-processing circuit (Step S206).

Furthermore, for reading out another piece of management information (“Yes” at Step S208), the actuator 130 rotates the optical information recording medium 111 to change the θ_{y} angle by a predetermined angle (Δθ_{y3}), thereby setting the θ_{y} angle approximately in the middle of the angle range in which the subsequent management information is recorded (Step S210). And, the processing returns to Step S204. Reading out all the management information (“No” at Step S208) ends the reproduction processing of management information.

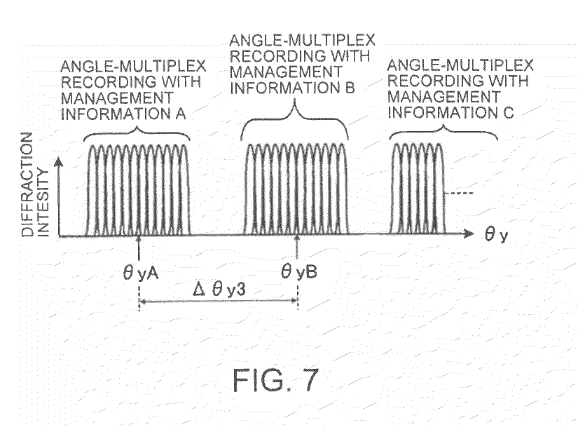

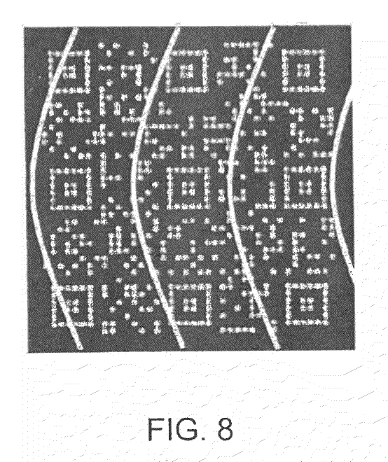

Here, the θ_{y} angle for reproducing management information is explained with reference to FIG. 7. The horizontal axis of the graph in FIG. 7 represents the θ_{y} angle, and the vertical axis represents the diffraction intensity. For example, when reproducing the management information A, θ_{yA} is set as the θ_{y} angle approximately in the middle of the recording angle range for the management information A at Step S202. The management information A is read out by irradiating the optical information recording medium 111 with a reference beam at an angle of θ_{yA}. For subsequently reading out the management information B, the θ_{y} angle is changed by a predetermined angle Δθ_{y3} to set the θ_{y} angle approximately in the middle of the recording angle range for the management information B at Step S210. And, the management information B is read out by irradiating the optical information recording medium 111 with a reference beam at an angle of θ_{yB}. Thereby, the management information A and the management information B can be reproduced quickly and exactly.

In addition, as mentioned above, the same pieces of management information are recorded over the recording angle range, and the θ_{y} angle, therefore, does not need to be set strictly in the middle angle of the recording angle range. Furthermore, it is not necessary to fit to the reproduction conditions of specific page data. Even if brightness of reproduction images varies as a result of a disagreement with reproduction conditions, it is surely possible to read out page data recorded on some pages close to each other.

In case that a large difference between temperatures for recording and reproducing generates a crosstalk, fractions of two or more pages could be displayed side by side. However, the same management information recorded connects fragmentary reproduction images from two or more pages, thereby yielding complete management information. For this reason, predetermined management information can be reproduced without a special adjustment of wavelength or angle. Therefore, management information can be reproduced rapidly and certainly.

As mentioned above, according to the first embodiment of the invention, it is not necessary to exactly adjust reproducing conditions, and it is possible to acquire management information as an exact reproduction image even if a crosstalk is generated. Therefore, it is possible to reduce time to reproduce user data after setting the optical information-recording medium 111 into the recording/reproducing apparatus 100, i.e., to rapidly access user data soon after starting up the holographic memory recording/reproducing apparatus 100.

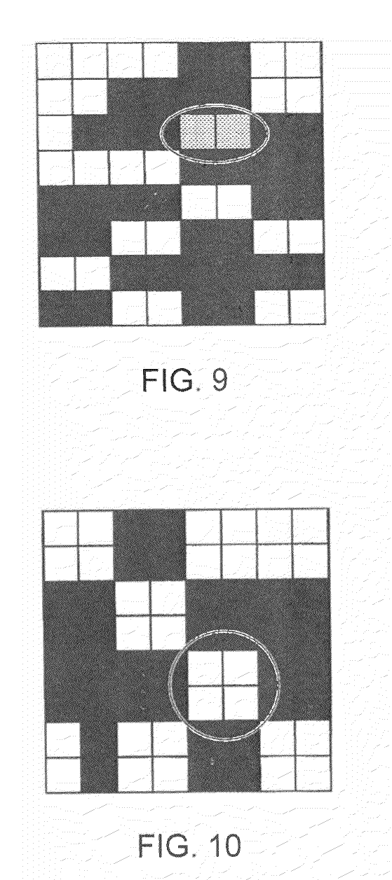

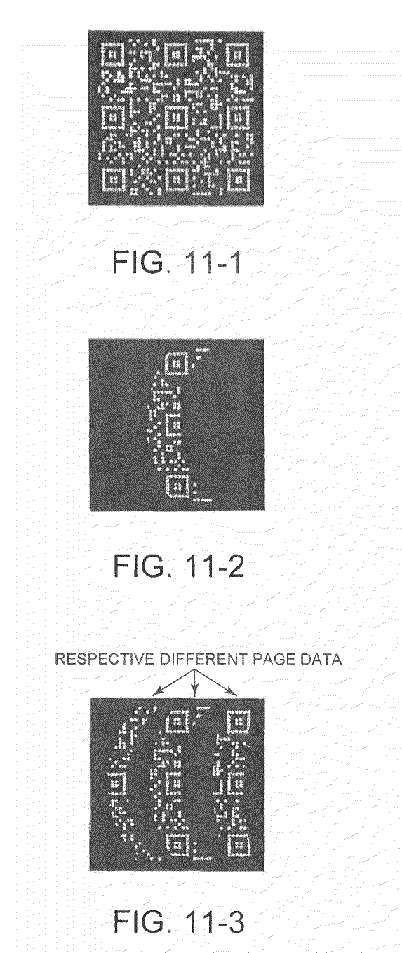

Alternatively, the spatial beam modulator 107 may express 1-bit information with 2 pixels as a modified example of the holographic memory recording/reproducing apparatus 100 according to the first embodiment, as shown in FIG. 9. Furthermore, as another example, the spatial beam modulator 107 may express 1-bit information with 4 pixels of two-row by two-column, as shown in FIG. 10.

When fractions of adjacent pages are reproduced side by side so that the relative angle among the reference beam, the information beam and the optical information recording medium 111 for recording is quite different from that for reproducing, the position of the reproduction image could shift in some cases. In such a case, a bit error rate increases. Then, a bit error rate (bER) can be reduced by expressing 1 bit with two or more pixels as mentioned above. Thereby, although the amount of information decreases, the amount of relative position shifts to 1 bit can be reduced. Thereby, a reproduction image can be stably read out.

### Second Embodiment

A holographic memory recording/reproducing apparatus according to a second embodiment records management information continuously in the predetermined θ_{y} angle range. The holographic memory recording/reproducing apparatus according to the first embodiment changes the θ_{y} angle, and sets the θ_{y} angle to a predetermined angle. Then, a beam is emitted from the laser light source thereof. And, the emission of the beam is once stopped. The θ_{y} angle is changed again, and set to a predetermined angle. Then, the beam is emitted from the laser light source thereof. Thus, management information is recorded at intervals of Δθ_{y1}.

On the other hand, the holographic memory recording/reproducing apparatus according to the second embodiment changes the θ_{y} angle from a predetermined θ_{y} angle in the recording angle range of Δθ_{y1}×N while continuing to emit a beam from the laser light source thereof. Thereby, continuous management information is recorded in the recording angle range of Δθ_{y1}×N as in analog recording. In addition, when the actuator 130 changes the θ_{y} angle by a minimum angle unit which the actuator 130 can control or by a predetermined unit of Δθ_{y1} or less as in digital recording, a beam is emitted continuously from the laser light source while changing the θ_{y} angle within the recording angle range.

Thus, when a variation in brightness of reproduction images arises from the disagreement with the reproducing conditions, continuously recording management information leads to a reduction in the variation. Therefore, management information can be reproduced with more accuracy.

In addition, the composition and operation of the holographic memory recording/reproducing apparatus according to the second embodiment are the same as those of the holographic memory recording/reproducing apparatus according to the first embodiment except the way of recording management information.

What is claimed is:

1. An optical information recording method, comprising:
converting a light beam emitted from a light source into an information beam carrying information by using a spatial beam modulator;
focusing the information beam on an optical information recording medium including an information recording layer in order to irradiate the optical information recording medium with a reference beam and the information beam so that the reference beam and the information beam intersect with each other on the information recording layer by using an optical component, the information recording layer being capable of recording information as a hologram due to interference fringes generated by interference between the information beam and the reference beam;
rotating the optical information recording medium or the optical component by using a drive unit to change a relative angle among the information beam, the reference beam and the optical information recording medium for performing angle-multiplex recording of the information onto the information recording layer; and
recording management information at two or more relative angles having an angle interval smaller than twice at least a first null angle, the management information being used when reading out user information recorded on the optical information recording medium.

2. The method according to claim 1, wherein the relative angles are changed while continuing irradiation of the information beam and the reference beam to continuously record the same pieces of information as the management information to be used for reading out user information by multiplex recording.

3. The method according to claim 1, wherein the light beam is converted into the information beam by the spatial beam modulator to express the management information of 1-bit with two or more pixels.

4. The method according to claim 1, wherein address information to specify a position of the user information recorded on the optical information recording medium is recorded as the management information.

5. The method according to claim 1, wherein a temperature for recording the user information on the optical information recording medium is recorded as the management information.

6. The method according to claim 1, wherein an angle interval for recording the user information on the optical information recording medium is recorded as the management information.

7. The method according to claim 1, wherein a wavelength of the light source for recording the user information on the optical information recording medium is recorded as the management information.

8. The method according to claim 1, wherein two or more pieces of the management information are recorded at intervals of the relative angle in a range of angles to be larger than a first null angle.

9. The method according to claim 8,
wherein
two or more pieces of first management information are recorded at intervals of the relative angle in a first range of angles to be larger than a first null angle; and
wherein
two or more pieces of second management information are recorded at intervals of the relative angle in a second range of angles to be separated from the first range of angles by an angle larger than the first null angle.

10. An optical information recording apparatus, comprising:
a spatial beam modulator to modulate laser light spatially to generate an information beam carrying information, the laser light being emitted from a light source;
an optical component to focus the information beam on an optical information recording medium including an information recording layer in order to irradiate the optical information recording medium with a reference beam and the information beam so that the reference beam and the information beam intersect with each other on the information recording layer, the information recording layer being capable of recording information as a hologram due to interference fringes generated by interference between the information beam and the reference beam;
a drive unit to rotate the optical information recording medium or the optical component; and
a control unit to perform angle-multiplex recording of the information on the optical information recording medium by controlling the light source to emit the laser light while driving the optical information recording medium or the optical component so that a relative angle among the information beam, the reference beam and the optical information recording medium are changed,
wherein
the control unit records the same piece of management information at two or more relative angles having an angle interval smaller than twice at least a first null angle; and the management information is used when reading out user information.
